(19) United States
(12) Patent Application Publication
(10) Pub. No.: US 2015/0017959 A1
(43) Pub. Date: Jan. 15, 2015

(54) METHOD FOR MANAGING THE ESTABLISHMENT OF A DIGITAL CONNECTION

(71) Applicant: ORANGE, Paris (FR)

(72) Inventors: Laurent Leboucher, Dallas, TX (US); Max Michel, Fontenay Aux Roses (FR); Salim Mounir Alaoui, Issy Les Moulineaux (FR)

(73) Assignee: ORANGE, Paris (FR)

(21) Appl. No.: 14/359,828

(22) PCT Filed: Nov. 20, 2012
(86) PCT No.: PCT/FR2012/052680

§ 371 Date: May 21, 2014

(30) Foreign Application Priority Data
Nov. 21, 2011 (FR) 11 60602

(51) Int. Cl. H04M 3/42

(52) U.S. Cl. CPC H04M 3/42068; H04M 3/4217; H04W 4/16
USPC 455/415

(57) ABSTRACT

The invention relates in particular to methods for managing: user communication terminals, the anonymisation of private user communication identifiers, and the use of private user communication identifiers. Upon designation of a social identifier of a first user, the aforementioned methods can be used to transmit one of the private communication identifiers associated with said first user to a communication establishment device for the purpose of anonymously connecting the first user with a second user having designated the social identifier.

### CROSS-REFERENCE TO RELATED APPLICATIONS

This application is a Section 371 National Stage Application of International Application No. PCT/FR2012/052680, filed Nov. 20, 2012, which is incorporated by reference in its entirety and published as WO 2013/076420 on May 30, 2013, not in English.

### FIELD OF THE DISCLOSURE

The present invention relates to the field of the connecting of people in a synchronous communication context such as telephony or instant or indeed asynchronous messaging such as electronic messaging.

### BACKGROUND OF THE DISCLOSURE

The notion of “telephone line” or more generally of “communication line” covers, in particular, wireless access by cellular networks of GSM type (for “Groupe Spécial Mobile”) for example. Moreover, on a “telephone line”, the transport of voice by cellular technologies of GSM type can be supplemented/replaced with transport of Voice over IP (for “Internet Protocol”) or VoIP, of video and/or of data.

Individuals are being confronted ever more with an increase in business or private calls and enquiries (telephone calls, instant discussions, email, etc.) which may in certain cases assume significant proportions and engender stress for the individuals.

In order to discriminate business enquiries from enquiries of a private nature, individuals may resort to the use of several mobiles, it then being possible for the business mobile to be turned off in the evening.

However, such services are not devoid of defects.

For example, having two mobiles gives rise to cost overheads and requires particular attention from the individual: it is thus necessary to remember to turn on the business portable in the early morning, to check the charge of the battery of both telephones, to turn off the business portable in the evening, etc.

Moreover, if for a given reason a person from his business sphere obtains the private telephone number, it may be very difficult to prevent this person using this number and/or distributing it among colleagues. In a similar manner, it is not desirable to distribute the business mobile telephone number, for example, among commercial direct marketing companies.

A need therefore exists to more effectively manage the connecting of people during telephone calls in particular to control the distributing of telephone contact data according, in particular, to the sphere of acquaintances of relevance to the person wishing to be connected with the recipient.

Document US20110069661 proposes to implement telecommunications functions between several users on the basis of a social network application, while thus maintaining confidential the identifiers of terminals (telephone numbers, IP address) of the participants. Accordingly, the identifier of the user in the social network and at least one terminal identifier are recorded. This makes it possible to receive a request for connection with the identifier of the user in the social network and to retrieve the respective terminal identifier so as to set up the communication with this terminal.

### SUMMARY

The invention proposes a method of connecting at least one communication terminal of a calling user with at least one communication terminal, associated with a private communication identifier, of a called user, said method comprising the following steps:
(a) receiving a connection request (dmd_mr2(is_α), m2) arising from the communication terminal of the calling user (UE) and indicating a social identifier of said called user, at least one social identifier of a user being associated with at least one private communication identifier of a communication terminal of the called user;
(b) identifying (102, 105, m3) at least one private communication identifier on the basis of said social identifier of the called user indicated in said connection request as a function of at least one reachability rule (105), configured by the called user, associated with the private communication identifiers;
(c) transmitting (106) an appeal for setting up a communication (req_com(id_com_n, UE), m4) of the communication terminal of the calling user with a communication terminal on which the called user is reachable on the basis of the identified private communication identifier.

Thus, the invention makes it possible to route the calls to of different communications terminals of the called party as a function of the reachability rules and of the caller.

Advantageously, the identifying step comprises a search for private communication identifiers associated by the called user with at least one social identifier of said called user, said search is performed as a function of a social identifier of said called user received in a connection request.

Advantageously, the identifying step comprises a selection of at least one private communication identifier of a communication terminal of said user from among the private communication identifiers arising from said search, the selection being dependent on predefined reachability rules (105).

Advantageously, the selection is, furthermore, dependent on a social identifier associated with a calling user of a communication terminal having sent said connection request to said social directory device.

The subject of the invention is a computer program product comprising instructions for the implementation of the connection method, when this program is executed by a processor.

The subject of the invention is a connection device comprising
(a) means (441) for receiving a connection request arising from the communication terminal of the calling user and indicating a social identifier of said called user, at least one social identifier of a user being associated with at least one private communication identifier of a communication terminal of the called user;
(b) means (442) for identifying at least one private communication identifier on the basis of said social identifier of the called user indicated in said connection request as a function of at least one reachability rule, configured by the called user, associated with the private communication identifiers;
(c) means (443) for transmitting an appeal for setting up a communication of the communication terminal of the calling user with a communication terminal on which the called user is reachable on the basis of the identified private communication identifier.

The subject of the invention is a connection interface method on the basis of a social network of at least one communication terminal of a calling user with at least one communication terminal, associated with a private communication identifier, of a called user, said method comprising the step of sending (101) a connection request (dmd_mr2(is_α), m2) arising from the communication terminal of the calling user (UE) and indicating a social identifier of said called user in said social network, at least one social identifier of a user being associated with at least one private communication identifier of a communication terminal of the called user, said connection request making it possible to identify (102, 105, m3) at least one private communication identifier on which said called user is reachable on the basis of said social identifier of the called user indicated in said connection request as a function of at least one reachability rule (105), configured by the called user, associated with the private communication identifiers.

Advantageously, said method comprises a step of receiving a message of updating (updt(is_α)) of the connection request interface as a function of the reachability rules.

Thus, the calling user can decide from among several modes of connection on which the called user is actually reachable at this instant the one most suitable for his communication with less risk of not seeing his connection request succeed.

A subject of the invention is a computer program product comprising instructions for the implementation of the connection interface method when this program is executed by a processor.

A subject of the invention is a method implemented by a communication terminal of a calling user (UE) consulting a social network, comprising the step of sending (101) a connection request (dmd_mr(is_α), m1) and indicating a social identifier of said called user in the social network consulted by the calling user, at least one social identifier of a user being associated with at least one private communication identifier of a communication terminal of the called user, said connection request making it possible to identify (102, 105, m3) at least one private communication identifier on which said called user is reachable on the basis of said social identifier of the called user indicated in said connection request as a function of at least one reachability rule (105), configured by the called user, associated with the private communication identifiers.

A subject of the invention is a computer program product comprising instructions for the implementation of the method implemented by a communication terminal of a calling user, when this program is executed by a processor.

A subject of the invention is a method implemented by a communication terminal of a called user (UR) comprising the step of receiving a communication setup appeal originating from a communication system having received, from a connection system, an appeal for setting up a communication (req_com(id_com_n, UE), m4) of a communication terminal of a calling user with a communication terminal on which the called user is reachable on the basis of an identified private communication identifier, said private communication identifier having been identified on the basis of a social identifier of the called user indicated in a connection request as a function of at least one reachability rule (105), configured by the called user, associated with the private communication identifiers, said connection request (dmd_mr2(is_α), m2) arising from the communication terminal of the calling user (UE), at least one social identifier of a user being associated with at least one private communication identifier of a communication terminal of the called user.

A subject of the invention is a communication terminal of a user comprising a device for consultation and interaction (122) with a social network allowing a sending (101) of a connection request (dmd_mr(is_α), m1) and indicating a social identifier of said called user in the social network consulted by the calling user, at least one social identifier of a user being associated with at least one private communication identifier of a communication terminal of the called user, said connection request making it possible to identify (102, 105, m3) at least one private communication identifier on which said called user is reachable on the basis of said social identifier of the called user indicated in said connection request as a function of at least one reachability rule (105), configured by the called user, associated with the private communication identifiers.

A subject of the invention is a social directory system in which each user is identified by a social identifier, in which said social directory system comprises:
a device for enriching said social directory system comprising a receiver of a connection interface, said connection interface allowing said social directory system to send (101) a connection request (dmd_mr2(is_α), m2) arising from the communication terminal of the calling user (UE) and indicating a social identifier of said called user in said social network, at least one social identifier of a user being associated with at least one private communication identifier of a communication terminal of the called user, said connection request making it possible to identify (102, 105, m3) at least one private communication identifier on which said called user is reachable on the basis of said social identifier of the called user indicated in said connection request as a function of at least one reachability rule (105), configured by the called user, associated with the private communication identifiers.

A subject of the invention is a system for providing a connection service, characterized in that it comprises:
a management device (42) for communication terminals of users comprising means for recording, in a set of private communication identifiers of a user, at least one private communication identifier declared by said user,
a device for anonymization (43) of private communication identifier of communication terminals of users, comprising means for associating a social identifier of a user with each of the private communication identifiers recorded in a set of private communication identifiers of communication terminals declared by said user,
a connection device (44) comprising
(a) means (441) for receiving a connection request arising from the communication terminal of the calling user and indicating a social identifier of said called user, at least one social identifier of a user being associated with at least one private communication identifier of a communication terminal of the called user;
(b) means (442) for identifying at least one private communication identifier on the basis of said social identifier of the called user indicated in said connection request as a function of at least one reachability rule, configured by the called user, associated with the private communication identifiers;
(c) means (443) for transmitting an appeal for setting up a communication of the communication terminal of the calling user with a communication terminal on which the called user is reachable on the basis of the selected private communication identifier.

### BRIEF DESCRIPTION OF THE DRAWINGS

Other characteristics and advantages of the invention will be further apparent on reading the description which follows. The latter is purely illustrative and must be read with regard to the appended drawings in which:

FIG. 1 illustrates the particular representation of a method of managing communication identifiers in an embodiment of the invention,

FIG. 2 illustrates the particular representation of a method of anonymization and of a method of enrichment in an embodiment of the invention,

FIG. 3 illustrates the particular representation of the exchanges during the implementation of the set of methods in an embodiment of the invention, in particular method of managing communication identifiers, method of anonymization, method of enrichment and method of usage,

FIG. 4 illustrates an exemplary architecture of a communication network in an embodiment of the invention,

FIG. 5 illustrates the particular representation of a method of calling an opposite party by telephone in an embodiment of the invention;

FIG. 6 illustrates the matching of social identifiers with private communication identifiers in an embodiment of the invention;

FIG. 7 is an exemplary device for managing connection in a particular mode of the invention.

### DETAILED DESCRIPTION OF ILLUSTRATIVE EMBODIMENTS

The “connecting of a calling user with a called user” is the act, by electronic pathway, of setting up a connection between a terminal of a calling user and a terminal of a called user. This connecting is then requested by the calling user.

A “private communication identifier” is a user identifier associated with a communication terminal: for example, the portable telephone number is a private communication identifier associated with a mobile telephone comprising a SIM card associated with a user's mobile telephone account. An electronic messaging address is a private communication identifier associated with a user's instant messaging account.

A “private communication identifier” is termed a “private communication identifier” when said “private communication identifier” has not been published or distributed in particular through a telephone directory or an electronic address directory.

A “social identifier” is an identifier associated with a given user in a social directory that may or may not be used by a social network. The user can then use his social identifier in social interactions with the other people identified in this social directory. For example, this social identifier can be the full name of a user, which name is then registered on the user's identity card (such as “John Smith”) or a pseudonym.

The “set of private communication identifiers of a user” is a set containing, for example, two fixed-telephone numbers, a mobile telephone number and an electronic address. These private communication identifiers have, for example, been previously recorded in a database by the user.

The selection within private communication identifiers of a user of a private communication identifier satisfying reachability rules in particular as a function of the calling user allows setup of a communication between a communication terminal of the calling user and the communication terminal corresponding to the selected private communication identifier of the user, also then named the called user.

In a particular embodiment of the invention, the reachability rules can be dependent on the type of communication terminal of the calling user. Thus if the calling user is identified by a telephone number, if the called user has declared a telephone number and not an electronic messaging address for example, the communication will be set up between the communications terminals thus identified of the calling user and of the called user.

A “social directory” is a collection of social identifiers allowing users of a social directory to retrieve people or companies. Today, social directories are especially used by social networks to allow users to authorize or not authorize acquaintances to consult profile data, media such as photos, video, etc. The invention would make it possible to supplement the services provided by anonymous connecting (within the sense of information for communication setup and not social).

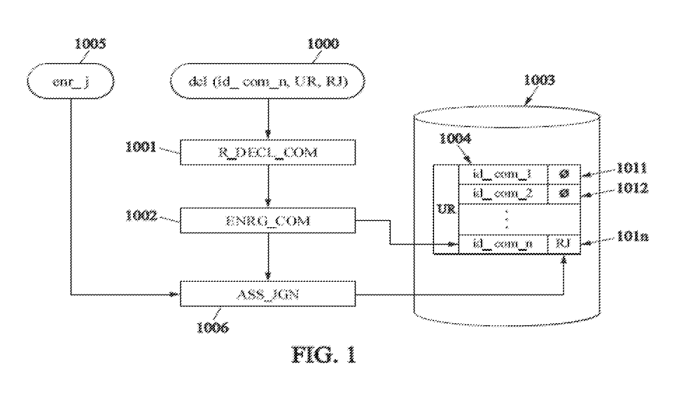

FIG. 1 illustrates the particular representation of a method of managing communication identifiers in an embodiment of the invention.

The method of managing communication identifiers of users comprises a recording ENREG_COM, in a set of private communication identifiers of a user (UR), of at least one private communication identifier id_com_n declared by said user UR. The recording makes it possible to transmit to a communication setup device (not illustrated in FIG. 1) at least one of the private communication identifiers (id_com_{—}1, . . . , id_com_n) associated with a social identifier of said user received in a connection request in an appeal for communication setup with a communication terminal of said user using said at least one of the private communication identifiers. The social identifier of said user has been, prior to the receipt of the connection request, associated with each of the private communication identifiers of said set of private communication identifiers ε(UR).

In particular, the recording method comprises a reception 1001 of a message of declaration 1000 of a new private communication identifier of a communication terminal (id_com_n) of a user (UR) triggering the recording 1002.

This recording 1002 allows the storage in particular in a memory or a database 1003 of the set of private communication identifiers of a user of the method of managing the communication identifiers.

In particular, each user (UR) can have a reserved memory space 1004 in the database 1003. Each private communication identifier of the user (id_com_{—}1, . . . , id_com_n) are stored in this reserved memory space 1004 in association with an identifier associated with the user (UR). The message 1000 advantageously contains an identifier UR making it possible to determine the user concerned in the declaration and the private communication identifier id_com_n to be associated with this user.

Thus, the recording step 1002 can consist of identifying the storage space associated with the user UR, and then in the storing of the private communication identifier id_com_n in this space.

In particular, the method of managing communication identifiers comprises an association 1006 of at least one reachability rule or information item RJ with at least one recorded private communication identifier id_com_n. The reachability rule can be either appended to the communication identifier declaration dcl(id_com_n, UR, <RJ>), or received separately.

If a reachability information item (RJ) is contained in the declaration message 1000, and if the recording of this information item is requested (1005), the reachability information item (RJ) is recorded (1006) in the memory space 1004 in association with the private communication identifier id_com_n.

The user can, by virtue of this method, configure reachability rules which govern the time periods or the locations where he can be called as a function of the users who call him or groups of users designated respectively by their social identifiers or by the identifiers of the acquaintance groups if the social network allows this categorization.

Thus, a user UR can declare all of these communication identifiers at an instant in time, or declare them as and when they are created or used by a social directory, and add, delete or indeed modify either at the same time or subsequently reachability rules associated with at least one of the declared private communication identifiers.

Notably, one or more reachability rules can be added to a private communication identifier declared subsequently to the association of a social identifier with this private communication identifier. Thus, the rules can be dependent on elements related to the social directory employing this social identifier. In particular, the method of managing communication identifiers can, during reachability rule creation and/or modification, recover the social identifiers and/or acquaintance group of the contacts of the social identifier associated with the communication identifier for which a reachability rule is edited (that is to say create, modify, or delete). Thus, the reachability rule may be dependent on at least one of the social identifiers or group of contacts.

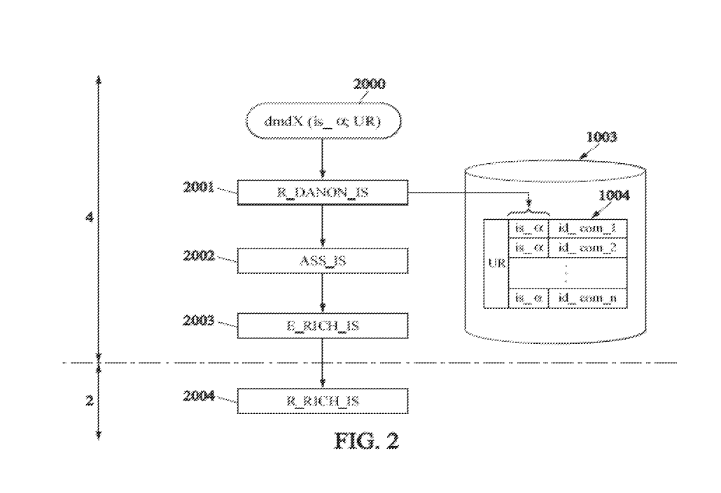

FIG. 2 illustrates the particular representation of a method of anonymization (carried out by an anonymous connection service 4) and of a method of enrichment in an embodiment of the invention.

The method of anonymization comprises an association 2002 of a social identifier of a user is_α with each of the recorded private communication identifiers id_com_{—}1 . . . id_com_n in a set of private communication identifiers declared by said user UR. The association makes it possible to transmit to a communication setup device (not illustrated) at least one of the private communication identifiers id_com_{—}1 . . . id_com_n associated with a social identifier of said user is a received in a connection request in an appeal for communication setup with a communication terminal of said user using said at least one of the private communication identifiers.

In particular, the method of anonymization comprises the reception 2001 of a request for anonymization of a social identifier dmd_X(is_α, UR). On receipt (2001) of an anonymization request message 2000 containing a social identifier (is_α) and the identifier of a user (UR), an anonymization can be carried out. This anonymization can therefore consist of an association of the social identifier (is_α) communicated with each of the private communication identifiers recorded for the user UR in the memory space associated with this user 1004.

Once the social identifier has been recorded in the memory space 1004, an enrichment of a social directory system can occur.

The method of enrichment comprises a receipt of an enrichment information item 2004. The enrichment information item allows a social directory system 2 to send a request for connection with a social identifier of a user. The connection request triggers a transmission to a communication setup device (not illustrated) at least one of the private communication identifiers associated with a social identifier of said user received in a connection request in an appeal for communication setup with a communication terminal of said user using said at least one of the private communication identifiers.

The enrichment information item is in particular a connection interface or a connection interface activation message.

In particular, the anonymous connection service 4 sends (2003) a message for the social directory system 2 which receives it and processes it (2004). This message contains a connection interface allowing the social directory system 2 to send a request for connection with the social identifier (is_α).

By way of illustration, this interface can be a piece of software used to effect Internet telephony from a computer (or “soft phone”). The communications are then effected by means of a microphone and a headset or loudspeakers linked to the sound card, for example.

This interface is displayed to the other users so that they can ask to be connected with the user UR, knowing only the social identifier (is_α) associated with the latter.

In particular, the method of enrichment comprises the sending of the anonymization request 2000. Notably, a user UR consulting his entry or profile in a social directory or social network 2 can ask to allow his acquaintances in this social directory to use at least one of his private communication identifiers (without distributing this communication identifier among these acquaintances) by triggering the dispatching by the social directory of the anonymization request.

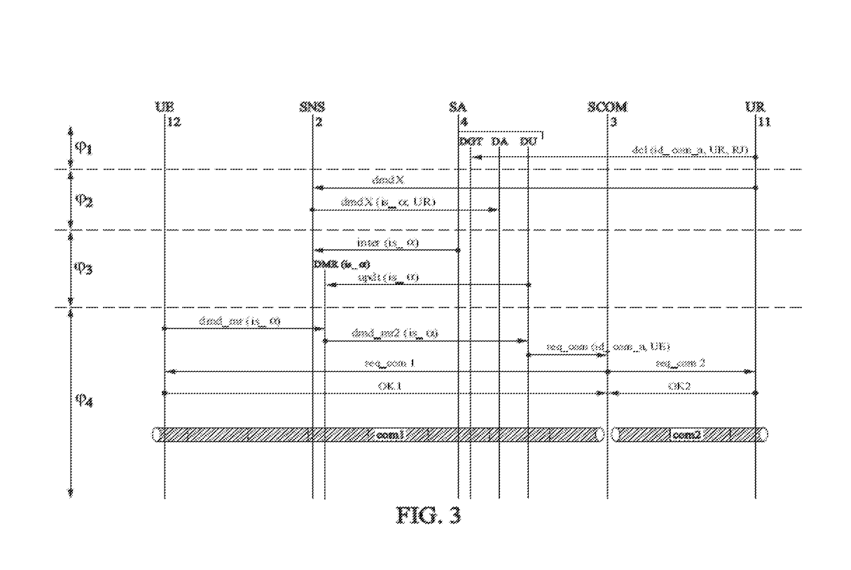

FIG. 3 illustrates the particular representation of the exchanges during the implementation of the set of methods in an embodiment of the invention, in particular a method of communication identifier management, a method of anonymization, a method of enrichment and a method of usage.

A user UR uses one of his communication terminals 11 to declare one of his communication identifier that the user UR desires not to distribute, that is to say to keep private, in this instance the communication identifier id_com_n used by the communication terminal 11: decl(id_com_n, UR) with an anonymization service provision system (SA, 4), that is to say allowing a communication to a terminal of a called user whose private communication identifier is known neither to the calling user nor to one of the communication terminals of the calling user.

The method of managing communication identifiers (φ1) comprises a receipt of this declaration by the user UR (11) of a new private communication identifier id_com_n as described previously with a device for managing the communication identifiers (DGT) of an anonymous connection service 4, and a recording of this new private communication identifier by the device for managing the communication identifiers (DGT).

In particular, the user UR (11) dispatches a declaration (dcl(id_com_n, UR)) while indicating his identifier UR, as well as the telephone number id_com_n (or other private communication identifier). As indicated previously, the message can also comprise a reachability rule (RJ).

Subsequently, the method of anonymization (φ2) can be triggered by this same user. The user UR logs on by means of a communication terminal 11 to a social directory service 2 so as to consult his profile or his entry with which a social identifier is_α is associated. The user UR then requests this anonymization (dmdX) by means of his communication terminal 11, that is to say asks that his acquaintances in this social directory 2 be allowed to use at least one of his private communication identifiers (without distributing this communication identifier among these acquaintances) by triggering the dispatching by the social directory 2 of the anonymization request dmdX(is_α, UR) to the anonymous connection service 4, in particular to an anonymization device DA of said anonymous connection service 4.

Then, the social directory service 2 informs the anonymous connection service 4 of this request while indicating the social identifier (is_α) associated with the user requesting this anonymization as well as the identifier UR of this user at the anonymous connection service (for example, a customer number for a mobile telephone operator). It has been possible for the identifier UR to have previously been configured by the user at the social directory service. The anonymous connection service 4 can hence execute the anonymization steps such as described previously (in particular in FIG. 2).

In particular, the anonymization device DA then associates the social identifier is_α of the user UR in this social directory 2 with the private communication identifiers of the user UR recorded in the anonymization service provision system 4: in this instance in particular with the private communication identifier id_com_n: is_α [symbol] id_com_n.

In parallel with the method of anonymization (φ2) implemented by the anonymous connection service 4, a method of enrichment (φ3) is implemented by the social directory service 2.

Notably, an enrichment message such as a connection request interface is dispatched after the anonymization request via a message iter(is_α) from the anonymous connection service 4 to the social directory service 3. The social identifier is_α enables the social directory service to know for which user this dispatched interface is associated. This enrichment message is either an interface which can be an application of “soft phone” type as described previously, or a simple information item making it possible to activate or to configure a pre-existing interface at the social directory service 2. Thus, an interface DMR(is_α) is created or configured at the social directory service. In particular, the social directory 2 then receives this interface and loads it onto the profile of the user UR. The social directory 2 then comprises, for the social identifier of the user UR, a connection request interface DMR(is_α).

New phases (φ1) of private communication identifiers management comprising the addition of private communication identifiers or of modification of reachability rules, and (φ2) of anonymization can occur at any time.

Moreover, a device for usage (DU) of the anonymous connection service 4 can update this interface DMR(is_α) as a function of the reachability rules configured by the user UR (e.g. “unavailable after 19 h”, etc.). This updating is carried out by the dispatching of a message of updating (updt(is_α)) from the device for usage to the social directory service.

In particular, a user UE consulting, by means of a communication terminal 12, the social directory 2 is informed by the social directory 2 that, in these contacts, the user UR allows a connection via this social directory 2. The device for usage DU can in this context update updt(is_α) the information items distributed by the connection interface relating in particular to the statuses of connection available for the social identifier is_α. In particular, if a reachability rule has been adjoined to the communication identifier id_com_n indicating that the user UE can use this communication identifier only from 9 h to 19 h, the connection status corresponding to this communication identifier id_com_n will pass from available to unavailable for the user UE in the connection interface DMR at 19 h.

If another user (UE) using, by means of a communication terminal 12, the social directory service desires to be connected (φ4) with the user UR, he can use the connection request interface DMR(is_α) recorded by the social directory service: the user UE is then a calling user and the user UR a called user.

On receipt of the connection request (dmd_mr(is_α)) originating from the user UE by the social directory service via this interface, this connection request (dmd_mr2(is_α)) is retransmitted to the device for usage DU of the anonymous connection service 4. The connection request comprises in particular the social identifier of the calling user UE in the social directory 2 and/or the communication identifier used by the communication terminal of the calling user UE with which the calling user UE desires to be connected with the called user UR: in this instance the communication identifier used by the communication terminal 12.

On receipt of this request (dmd_mr2(is_α)), the device for usage DU searches for at least one private communication identifier id_com_n associated with the social identifier is_α contained in this request in the database or memory 1003. The identification of the associated private communication identifiers can be dependent on reachability rules configured by the user UR, in particular on the social identifier of the calling user UE or on his membership of a group in the social directory 2. In this instance, the search provides the private communication identifier id_com_n used by the communication terminal 11 of the called user UR.

In particular, when the connection request comprises only the social identifier of the calling user UE, either the device for usage DU can search for a private communication identifier of the calling user UE associated with the social identifier of the calling user UE if he has recorded at least one communication identifier with the anonymization service provision system 4, or the device for usage DU can ask the calling user UE to provide a communication identifier by means of his communication terminal 12 with which he consults the social directory 2 (the request and the response thereto are in particular exchanged via the social directory).

Once the private communication identifier id_com_n has been identified, the device for usage DU sends an appeal for communication (req_com(id_com_n, UE)) with the communication service 3 (SCOM) comprising the private communication identifier thus retrieved id_com_n used by the communication terminal 11 of the called user UR, and a communication identifier (private or otherwise) used by a communication terminal of the calling user UE, in this instance the communication terminal 12.

The communication setup appeal is received by a communication system (SCOM, 3) which sets up two communication sessions or legs of a communication session: The communication service 3 then notifies (req_com1) the communication terminal 12 of the user UE (by a ring tone, for example, if the terminal is a telephone and the desired connection is a voice communication). This communication server 3 also notifies (req_com2) the communication terminal 11 associated with the private communication identifier id_com_n (by a ring tone, for example, if the terminal is a telephone and the desired connection is a voice communication). If the users UE and UR accept the connection (ok1 and ok2), a communication can then be set up between, on the one hand, the terminal of the user UE and the communication service 3, and, on the other hand, between the communication service 3 and the terminal of the user UR. The communication server thus makes it possible to set up a communication session ss_com between the communication terminal 12 of the calling user UE and the communication terminal 11 of the called user UR without the communication identifier of the called user UR being known to the calling user UE or to his communication terminal 12, or indeed respectively without the communication identifier of the calling user UE being known to the called user UR or to his communication terminal 11.

In particular, the social identifier of the calling user UE in the social directory 2 is transmitted to the communication terminal 11 of the called user UR, respectively the social identifier of the called user UR in the social directory 2 is transmitted to the communication terminal 12 of the called user UE. The social identifier is in particular transmitted by the communication system 3 in the communication setup appeal req_com allowing setup of the communication session or of the legs between the communication terminal 11 or 12 and the communication system 3. The communication system 3 has in particular received this social identifier from the anonymization service provision system 4. In particular, the social identifier of the calling user UE is either received from the social directory 2 by the anonymization service provision system 4, or retrieved by this anonymization service provision system 4 during an inverse search if the calling user UE has declared the communication identifier used by the communication terminal 12 to the anonymization service provision system 4.

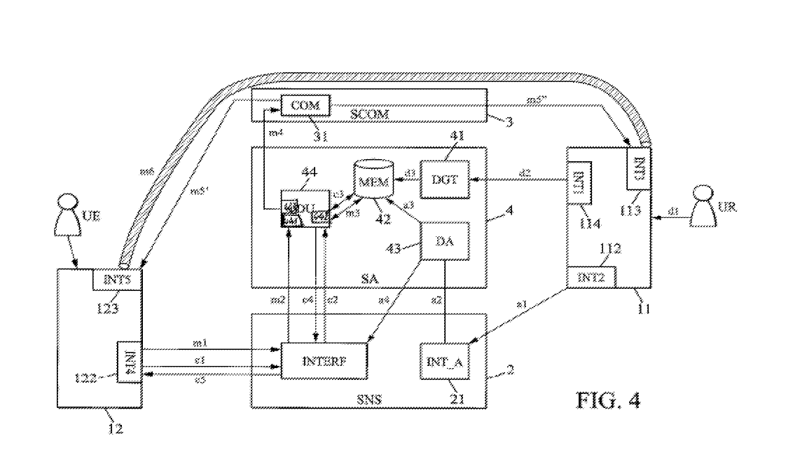

FIG. 4 illustrates an exemplary architecture of a communication network in an embodiment of the invention.

The architecture comprises a communication terminal 11 of a user UR, a communication terminal 12 of a user UE, a social directory system 2, a communication system 3 and an anonymization service provision system 4.

The communication terminal 11 of the user UR comprises in particular three communication interfaces 112, 113, and 114. The communication terminal 11 of the user UR comprises a device for declaration of communication identifiers 114 to the anonymization service provision system. In particular, the communication terminal 11 furthermore comprises:
A device for requesting anonymization 112 from a social directory 2,
A sender/receiver 113 allowing setup of a communication by a communication system 3.

Optionally, the anonymization requesting device 112 is a device for consultation and interaction with a social directory 2.

The communication terminal 12 of the user UE comprises, in particular, a device for consultation and interaction 122 with a social directory 2, and a sender/receiver 113 allowing setup of a communication by a communication system 3.

The social directory 2 comprises an enrichment device 21 able to transmit a request for anonymization of a social identifier and to receive an information item regarding enrichment of a social identifier such as a connection request interface or an information item regarding activation of a connection request interface.

Optionally, the social directory 2 furthermore comprises a provision and interactions interface 22 comprising in particular a connection request interface (not illustrated).

The anonymization service provision system 4 comprises:
A device for managing the communication identifiers 41,
An anonymization device 43, and
A device for usage of the private communication identifiers 44.

In particular, the anonymization service provision system furthermore comprises a database 42 in which are recorded by the management device 41 the declared private communication identifiers and, if appropriate, the associated reachability rules, and are associated with said private communications identifiers the social identifiers.

Thus, a user UR declares d1 at least one communication identifier that he desires to keep private by means of a communication terminal 11. The declaration device 114 transmits the declaration of private communication identifier d2 to a declaration device 41 of the anonymization service provision system 4 which records d3 it in particular in the database 42.

The declaration device 41 is in particular an Internet site that the user UR can consult by means of a communication terminal. The Internet site allows in particular secure access to a personal page on which the user can declare new communication identifiers as private, modify his declarations, or delete a communication identifier. In particular, in addition to the communication identifier, a category can be allocated such as “business” or “family” making it possible to group together the communication identifiers usable by a group of identified acquaintances.

This Internet site also allows the user UR to manage his reachability rules.

The same user UR consults his entry or his profile on a social directory 2 by means of a communication terminal, in this instance the communication terminal 11 (not illustrated). The communication terminal 11 by means of the anonymization request device 112 transmits on triggering by the user UR an anonymization request a1 to the enrichment device 21 of the social directory 2 (hosting for example a social network) which follows up the request a2 to the anonymization device 42 of the anonymization service provision system 43.

The anonymization device 42 associates a3 the social identifier of the user UR in this social directory 2 with the private communication identifiers of this user UR that are recorded (in particular in the database 42).

In particular, the anonymization device 42 transmits an enrichment information item a4 such as a connection request interface either directly into the provision and interaction device 22 of the social directory, or via the enrichment device 21 (not illustrated). In an alternative manner (not illustrated), the sending by the enrichment device 21 of an anonymization request a2 triggers the activation of a connection request interface associated with the social identifier of the user UR of the provision and interactions device 22.

An updating of the interface can be requested by any terminal of a user (c1) from the interface 22 so that the latter informs thereof anonymous connection service 4. This updating can also, as a supplement or as a variant, be automatically requested (c2) by the social directory service from the anonymous connection service 4. This updating makes it possible to ascertain for example the updated status of the status of a user (defined, for example, by the reachability rules that this user has configured). The updating request c2 is in particular performed at the start of the consultation c1 and optionally in a periodic manner thereafter.

The device for usage 44 of the anonymization service provision system 4 checks c3 the available types of connection (synchronous such as telephone, instant messaging, chat, etc. or asynchronous such as electronic messaging, SMS, etc.) in particular as a function of the date, and/or of the time, and/or of the social identifier of the user UE and/or of his membership of an acquaintance group of the contact, etc. The device for usage 44 returns c4 statuses of connection for each type of connection available for each of the contacts for which a connection is available to the provision and interaction device 22 which provides them c5 to the communication terminal 12. The user UE is thus informed (c5) of the reachability status of the user UR.

Moreover, when a user UE desires to be connected with the user UR, he can interact (m1) with the social directory service 2 via this interface 22. The interface 22 receiving the connection request (m1), it transmits it to the anonymous connection service 4 in a message (m2) at means of reception (441) of the device for usage 44. Means of identification 442 of this device for usage then search (m3) in the database or memory 42 for whether a private communication identifier associated with the social identifier contained the message (m2) exists. Under the assumption that at least one private communication identifier exists (and is usable by the user UE by virtue of the reachability rules configured by the user UR), the transmission means 443 transmit (m4) the private communication identifier to the communication service 3 on the interface 31 thereof. The communication system 3 receiving the communication appeal m4 sets up two communication legs m′5 and m″5 respectively to a communication terminal of the calling user UE: in this instance the communication terminal 12, and a communication terminal of the called user UR: in this instance the communication terminal 11 so as to set up the communication session m6 between the communication terminals 11 and 12 respectively of the called user UR and of the calling user UE without transmitting private communication identifiers.

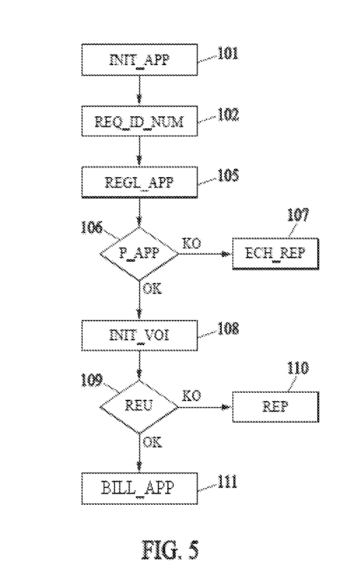

FIG. 5 illustrates the particular representation of a method of calling an opposite party by telephone in an embodiment of the invention.

During the initialization of a telephone call (step 101), the caller does not have the telephone number of the called party. Indeed, the caller knows only the social identifier of the called party in particular on a social network (the caller is, in particular, an acquaintance of the called party): for example, his full name, an avatar or else a numerical identifier specific to the social network considered.

This so-called “social” identifier is then transmitted to the telephone operator instead of the telephone number, for example, in a GSM or SIP (for “Session Initiation Protocol”) appeal or else even an appeal separate from the telephone call itself, such as an HTTP (for “HyperText Transfer Protocol”) appeal.

The telephone operator then undertakes a search for a real telephone number of the called party (step 102) associated with this social identifier. This placed search can be carried out with the aid of a local database managed by the operator, or by an appeal made of a third party service, with the aid of a specific API (for “Application Programming Interface”).

If the called party does not have any telephone number or if the latter does not desire to be able to be called by the caller, the call can then be declared a failure. The latter step is optional. A standard message can also be notified to the caller to indicate to him that this call cannot succeed.

The operator can verify that the reachability rules, configured by the person designated as being the called party, are satisfied (step 105). For example, these rules can prohibit any call after 19 h on the business telephone number. Moreover, these rules can make it possible to filter the calls by taking account of the community relationships set up in the social network, for example, based on the notion of groups, of lists or of circles (friends, simple acquaintance, colleague, etc.). These rules can also be specific for each of the community relationships of the person designated as being the called party.

If the rules of the person designated as being the called party do not allow his call (test 106, output KO), the call is declared a failure. This failure can be notified to the caller, or else the caller can be directed to the voice messaging of the called party, if the called party has authorized the leaving of a message (step 107).

Otherwise (test 106, output OK), the telephone call is initiated by the telephone operator (step 108): thus, the called party can be notified by ring tone of the caller's desire to set up a telephonic communication with him.

Then, if the called party picks up (test 109, output OK), a charging invoice is set up at the telephone operator so as to be able to bill the call to the caller (or the called party according to the charging model used) or deduct the call from his telephone price plan (step 111).

Otherwise (test 109, output KO), the call can be routed to the telephone messaging of the called party (step 110).

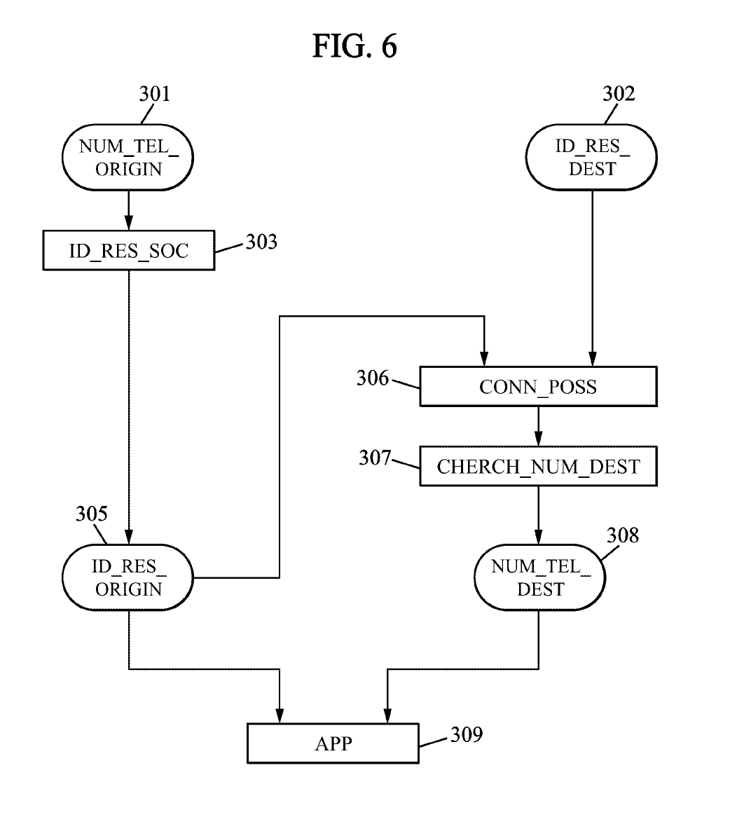

FIG. 6 illustrates the search for the private communication identifiers associated with social identifiers in an embodiment of the invention.

Indeed, during the setup of a telephone call according to the method detailed hereinabove, the caller does not know the telephone number of his opposite party. His connection request dispatched to the operator contains only the social identifier 302 of the recipient (i.e. the called party). Moreover, the operator knows the telephone number 301 of the caller (directly, for example, through its presence in the appeal or else indirectly, through the identification carried out during access to the operator's mobile network).

The operator is then able to determine (step 303) the social identifier 305 of the caller in the social network. The correspondence between the social identifier of the caller and the latter's telephone number can, for example, be prerecorded in a database at the operator by the caller or be recovered dynamically from a social network, by way of illustration, by means of an SOAP (for “Simple Object Access Protocol”), HTTP (for “HyperText Transfer Protocol”), etc. appeal.

On the basis of the caller's social identifier, the operator is then able to determine (step 306) whether the person designated (i.e. the called party) by the social identifier 302 belongs to the circle of friends, acquaintances, colleagues, etc. of the caller and optionally which of the rules are applicable for the filtering of calls. Accordingly, the operator can access APIs of the social network.

If it is determined that the caller can be connected with the called party, the telephone number 308 of the called party can be determined (step 307) if the latter has been prerecorded with the operator or if the latter is known to the social network.

Thus, on the basis of the social identifier of the caller and the telephone number of the recipient, it is possible to notify (step 309) the latter without disclosing the telephone number of the caller to the recipient, and without disclosing the telephone number of the recipient to the caller.

Ultimately, this method allows the telephone operator to determine the users having to be connected without the caller knowing the telephone number of the called party.

Moreover, the operator may also not feature in the call notification to the called party of the telephone number of the caller. The operator then acts as a trusted third party, able to connect the users but ensuring the confidentiality of the connection.

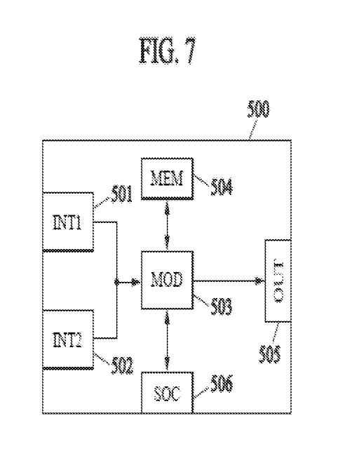

FIG. 7 is an exemplary device for managing connection in a particular mode of the invention.

This device 500 is, for example, a server managed by a mobile telephone operator.

The server has an interface 501 so as to receive a message containing a private communication identifier of the calling user and a social identifier of the called user.

Once received and extracted, these identifiers are communicated to the “correlation and decision” module 503. This module 503 can, for example, store these identifiers in the memory 504 for subsequent use.

This module 503 then determines a social identifier of the calling user associated with the private communication identifier received. Moreover, this module 503 also searches for at least one private communication identifier of the called user associated with the social identifier of the called user. These determinations/searches can be carried out by virtue of a lookup table of correspondences between social identifiers and private communication identifiers recorded previously in the memory 504. The users can be afforded the possibility of creating and modifying the part of the lookup table associated with them. Moreover, these determinations can be carried out by calling upon a service of an external social network via the interface 506: an API provided by the social network can allow the module 503 to ascertain the various usable identifiers associated with the private communication identifier of the calling user.

Moreover, this same module 503 can search for a private communication identifier of the called user as a function of reachability rules and in particular as a function of the calling user. For example, the module searches for a mobile telephone number of the called party that the calling user can use at the time of the connection request. A message is then dispatched via the interface 505, for example, to a server/communication setup module.

The functional diagram presented in FIG. 1, 2, 4, 5 or 6 is a typical example of a program, certain instructions of which can be carried out at the anonymous connection service, the social network, the communication server or at a mobile appliance. In this respect, FIG. 1, 2, 4, 5 or 6 can correspond to the flowchart of the general algorithm of a computer program within the meaning of the invention.

Of course, the present invention is not limited to the embodiments described hereinabove by way of examples; it extends to other variants.

Other embodiments are possible.

For example, the figures hereinabove predominantly present mobile terminal user connection through a voice communication (telephone call for example), but one and the same presentation can be given with connection through email, instant messaging, SMS, MMS, Voice over IP (for “Internet Protocol”) whose signaling is in particular carried out by the SIP (for “Session Initiation Protocol”) protocol.

Moreover, when the description refers to a telephone number, it is also possible to substitute the latter for a unique identifier known to the operator or for an identifier associated with the SIM card of a user of the mobile terminal (or more generally, any communication identifier).

The method described hereinabove is applicable to any type of social network, several social networks even being able to coexist for one and the same user. For example, a first electronic contact can be reachable on a personal mobile line of a subscriber associated with a social network of friends and a second electronic contact can be reachable on a company line associated with a company social network. The same line can be used at the same time by several social networks.

The call notification can be dispatched to the recipient terminal in the form of a direct communication, of a WAP (for “Wireless Application Protocol”) message, of an SMS (for “Short Message Service”), of an MMS (for “Multimedia Message Service”), of a USSD (for “Unstructured Supplementary Service Data”) message.

Thus, the invention would allow a directory of yellow pages or white pages type to allow people whose telephone number is today red listed to appear in a simple social directory without their telephone number being published but while allowing their acquaintance to be placed in communication with them easily.

It could also be envisaged to provide users with services of network address-book type in which those people who so desire could provide just a public social identity. The social address-book service will connect with the anonymous connection service to allow setup of a communication with its people.

In a possible embodiment, for a connection of a calling user with a called user, it is possible to envisage the steps:
in an optional manner, on presentation of a private communication identifier of the calling user, determine a social identifier of the calling user associated with the private communication identifier of the calling user,
on presentation of a social identifier of the called user, determine at least one private communication identifier of the called user associated with the social identifier of the called user,
on satisfaction of a reachability rule which can be dependent on the calling user's membership of a subset of the network of acquaintances of the called user in a social directory, and of reachability rules set up by the called user, decide the connection of the calling user with the called user on the basis of the private communication identifier of the calling user and a private communication identifier of the called user thus selected.

Thus, the private communication identifier of the selected called user is not apparent to the calling user. The connection can then be such that the private communication identifier of the calling user is not apparent, for example, to the called user either.

The invention makes it possible to place the calling user in communication with the called user while not communicating any information relating to the private communication identifier of the called user to the calling user. It is possible not to communicate any information relating to the private communication identifier of the calling user to the called user. Thus, the connection within the meaning of the invention ensures their anonymization (for example, telephone numbers, instant messaging addresses, etc.) for each of the connected parties.

The control of the use of the private communication identifier and its distribution among its contacts within a social directory, or indeed a social network, is then better mastered and is therefore improved.

In a possible embodiment, the selection of a private communication identifier of the called user can be performed as a function of predefined selection rules: reachability rules.

A user can, for example, associate with his social identifier a large number of private communication identifiers (for example, two instant messaging addresses, a business fixed-telephone number, a personal mobile telephone number), according to an “electronic visiting card”. Nonetheless, he may desire that some of these private communication identifiers not be usable by certain users and/or at certain times of the day. Thus, reachability rules, for example, parametrized by this user, can allow selection of private communication identifiers from among all the private communication identifiers recorded by this user. The selection can then return one or more private communication identifiers that are usable at a given time and by a given potentially calling user.

Furthermore, the method can comprise verification of satisfaction of compatibility of the communication terminal of a calling user with a communication terminal associated with a selected private communication identifier of the called user. In the case of non-satisfaction of the compatibility criterion, the method can comprise a notification of the calling user.

Thus, if the private communication identifier of the calling user and the identifier selected within the private communication identifiers of the called user are not compatible, the calling user can be informed thereof. For example, the notification can pertain to the fact that no compatible private communication identifier for the called user has been found or that the reachability rules configured by the called user do not allow connection of the calling user with the called user at the time of the connection request.

Furthermore, the social identifier of the calling user can be displayed by the display device associated with the terminal of the called user.

Indeed, this display can allow the second user to identify the person desiring to be connected with him. In the absence of display of a telephone number, another identifier can therefore then be displayed as a social identifier.

In a similar manner, the social identifier of the called user can be displayed by the display device associated with the terminal of the calling user.

Thus, this display can allow the calling user to verify that, in the absence of display of a telephone number of his opposite party, the person called is indeed the right one, by displaying his social identifier.

As a supplement or as a variant, the social identifier of the calling user and the social identifier of the called user can be identifiers in a social network.

A social network can comprise a set of users linked together by an on-line social networking service implemented on a communication network, for example, the Internet. On this social network, users can usually share information (photos, videos, etc.) with groups of acquaintances: friends, colleagues, etc.

Furthermore, the calling user can be in a group of acquaintances of the called user. The predefined reachability rules can comprise at least one reachability rule governing the private communication identifiers as a function of the group of acquaintances.

By way of illustration, the called user can configure certain reachability rules so that the personal mobile telephone number is not usable by the group of acquaintances of his office colleagues.

Thus, the called user can finely manage the connection parameters and protect his privacy.

Moreover, the predefined reachability rules can comprise at least one reachability rule governing the selection of private communication identifiers of the called user as a function of a temporal datum.

For example, the called user can configure certain reachability rules so that the business mobile telephone number is not usable after 19 h and/or at the weekend.

Furthermore, the private communication identifier of the calling user and at least one of the private communication identifiers of the called user can relate to mobile telephony.

Thus, a connection can be carried out, the telephone operator being able to be in charge of matching the social identifiers with the corresponding private communication identifiers.

In one embodiment, the calling user can have a list of contacts; in a social directory, the user can have a book of contacts which consists solely of social identifiers allowing the user to recognize for each of the social identifiers an associated user. Then, the method can comprise, for at least one contact (a called user) and after determination of private communication identifiers of said called user, an indication regarding the existence of a private communication identifier of said called user making it possible to connect the calling user with the called user.

The contacts can be users as described previously. For example, in a dynamic manner, the user can visually determine which means are the ones allowing connection with his contacts. Indeed, the private communication identifiers can thus comprise private communication identifiers that are usable at a given instant to connect the calling user and the contact: the called user. For example, the indication can then consist of the display of a specific icon as a function of the number and of the type of private communication identifiers. If no private communication identifiers is selected, the calling user can be informed that connection is not possible. If the selected private communication identifiers comprise only an email address, the calling user can be informed that connection is possible only by means of instant messaging or of electronic messaging, etc.

Of course, other types of indication can be envisaged like sound indications.

The invention is aimed at a method of management of communication terminals of users, said management method comprising a recording, in a set of private communication identifiers of a user, of at least one private communication identifier declared by said user, said recording making it possible to transmit to a communication setup device at least one of the private communication identifiers associated with a social identifier of said user received in a connection request in an appeal for communication setup with a communication terminal of said user using said at least one of the private communication identifiers, said social identifier of said user having been, prior to the receipt of the connection request, associated with each of the private communication identifiers of said set of private communication identifiers.

Thus, the present invention allows better management of the private communication identifiers by facilitating the use of private communication identifier allowing anonymization of the connection, that is to say to make it possible to place a communication terminal of a calling user in communication with a communication terminal of a called user on the request of the calling user without the calling user or his communication terminal knowing the communication identifier (in particular the telephone number) used by the communication terminal of the called user.

In one embodiment, the management method comprises the association of at least one reachability rule with at least one recorded private communication identifier. Thus, the invention makes it possible to filter the communications to a communication terminal of a user not only as a function of at least one reachability rule such as the time, the location, the diary, the calling user (in particular of his membership of a specific social group of a social directory system), the calling communication terminal, etc.

The invention is also aimed at a computer program product comprising instructions for the implementation of the method hereinabove, when this program is executed by a processor.

The invention is also aimed at a device for the implementation of the method, for management of communication terminals of a user, this device comprising:
means for recording, in a set of private communication identifiers of a user, at least one private communication identifier declared by said user,
   said recording making it possible to transmit to a communication setup device at least one of the private communication identifiers associated with a social identifier of said user received in a connection request in an appeal for communication setup with a communication terminal of said user using said at least one of the private communication identifiers,
   said social identifier of said user having been, prior to the receipt of the connection request, associated with each of the private communication identifiers of said set of private communication identifiers.

Such a device can comprise, for example, a central or connection server, as described with reference to the figures hereinafter by way of wholly non-limiting example.

The invention is also aimed at an association for an anonymization of a private communication identifier of a communication terminal of a user. It is aimed more particularly at a method of anonymization of private communication identifiers of users, said method comprising an association of a social identifier of a user with each of the private communication identifiers recorded in a set of private communication identifiers of communication terminals declared by said user, said association making it possible to transmit to a communication setup device at least one of the private communication identifiers associated with a social identifier of said user received in a connection request in an appeal for communication setup with a communication terminal of said user using said at least one of the private communication identifiers.

The invention is also aimed at a computer program product comprising instructions for the implementation of this method of anonymization, when this program is executed by a processor.

The invention is also aimed at a device for anonymizing private communication identifiers of users, for the implementation of this method, comprising:
means for associating a social identifier of a user with each of the private communication identifiers recorded in a set of private communication identifiers of communication terminals declared by said user,
   said association making it possible to transmit to a communication setup device at least one of the private communication identifiers associated with a social identifier of said user received in a connection request in an appeal for communication setup with a communication terminal of said user using said at least one of the private communication identifiers.

The invention is also aimed at a method of enrichment of a social directory system, comprising:

receipt of an enrichment information item, said enrichment information item allowing said social directory system to send a request for connection with a social identifier of a user,
said connection request triggering a transmission to a communication setup device at least one of the private communication identifiers associated with a social identifier of said user received in a connection request in an appeal for communication setup with a communication terminal of said user using said at least one of the private communication identifiers.

Such a method can be implemented, for example, with a computing entity driving a social network so as to load, for example, an interface of click-to-call type, as described further on.

The invention is also aimed at a computer program product comprising instructions for the implementation of the method of social directory enrichment, when this program is executed by a processor.

The invention is also aimed at a method of usage of private communication identifiers of users comprising a search for private communication identifiers associated by a user with at least one social identifier of said user. This search is advantageously performed as a function of a social identifier of said user received in a connection request. At least one of said private communication identifiers of a communication terminal of said user is transmitted to a communication setup device in an appeal for communication setup with said communication terminal.

This method can be implemented with a central or connection server so as to connect two users, this connection allowing the anonymization of the private communication identifiers of the users.

In one embodiment, this method comprises a selection of at least one private communication identifier of a communication terminal of said user from among the private communication identifiers arising from said search, the selection being dependent on predefined reachability rules and on a social identifier associated with a calling user of a communication terminal having sent said connection request to said social directory device.

Thus, the invention makes it possible to filter the communications to a communication terminal of a user not only as a function of at least one reachability rule such as the time, the location, the diary, etc., and also as a function of the calling user, in particular of his membership of a specific social group of a social directory system.

The invention is also aimed at a computer program product comprising instructions for the implementation of this method, when this program is executed by a processor.

The invention is also aimed at a device for usage of private communication identifiers of communication terminals of users, comprising:
search means for searching for private communication identifiers associated by a user with at least one social identifier of said user, said search means being configured so that said search is performed as a function of a social identifier of said user received in a connection request,
sending means for transmitting at least one of said private communication identifiers of a communication terminal of said user to a communication setup device in an appeal for communication setup with said communication terminal.

The present invention is also aimed at a communication terminal of a user comprising a device for declaration of communication terminals of said user, said declaration device transmitting to a terminals management device a declaration of at least one private communication identifier of said user, said declaration allowing recording means of said terminals management device to record, in a set of private communication identifiers of said user, said at least one private communication identifier declared by said user, said recording making it possible to transmit to a communication setup device at least one of the private communication identifiers associated with a social identifier of said user received in a connection request in an appeal for communication setup with a communication terminal of said user using said at least one of the private communication identifiers, said social identifier of said user having been, prior to the receipt of the connection request, associated with each of the private communication identifiers of said set of private communication identifiers.

The present invention is also aimed at a social directory system in which each user is identified by a social identifier, in which said social directory system comprises:
a device for enriching said social directory system comprising a receiver of a connection interface, said connection interface allowing said social directory system to send a request for connection with a social identifier of a user, said connection request triggering a transmission to a communication setup device in an appeal for communication setup with a communication terminal using at least one of the private communication identifiers associated with said social identifier.

The social directory system can be, for example, one or more computing entities driving a social network as described previously.

The present invention is also aimed at a system for providing an anonymization service, characterized in that it comprises:
a device for management of communication terminals of users comprising means for recording, in a set of private communication identifiers of a user, at least one private communication identifier declared by said user,
a device for anonymization of private communication identifier of communication terminals of users, comprising means for associating a social identifier of a user with each of the private communication identifiers recorded in a set of private communication identifiers of communication terminals declared by said user,
a device for usage of private communication identifiers of users, comprising means for searching for private communication identifiers associated by a user with at least one social identifier of said user, said search is performed as a function of a social identifier of said user received in a connection request, at least one of said private communication identifiers of a communication terminal of said user being transmitted to a communication setup device in an appeal for communication setup with said communication terminal.

The anonymization service system can, for example, be a platform for providing services ensuring anonymization of private communication identifiers such as, for example, a central or connection server.

1. A method of connecting at least one communication terminal of a calling user with at least one communication terminal, associated with a private communication identifier, of a called user, said method comprising the following steps:
(a) receiving a connection request arising from the communication terminal of the calling user (UE) and indicating a social identifier of said called user, at least one social identifier of a user being associated with at least one private communication identifier of a communication terminal of the called user;
(b) identifying at least one private communication identifier on the basis of said social identifier of the called user indicated in said connection request as a function of at least one reachability rule, configured by the called user, associated with the private communication identifiers; and
(c) transmitting an appeal for setting up a communication of the communication terminal of the calling user with a communication terminal on which the called user is reachable on the basis of the identified private communication identifier.

2. The connection method as claimed in claim 1, wherein the identifying step comprises a search for private communication identifiers associated by the called user with at least one social identifier of said called user, said search is performed as a function of a social identifier of said called user received in a connection request.

3. The connection method as claimed in claim 2, in which the identifying step comprises a selection of at least one private communication identifier of a communication terminal of said user from among the private communication identifiers arising from said search, the selection being dependent on predefined reachability rules.

4. The connection method as claimed in claim 3, in which the selection is, furthermore, dependent on a social identifier associated with the calling user of the communication terminal having sent said connection request to a social directory device.

5. A non-transitory computer readable medium comprising a computer program product stored thereon and comprising instructions for implementation of a method of connecting at least one communication terminal of a calling user with at least one communication terminal, associated with a private communication identifier, of a called user, when the instructions are executed by a processor, where in the method includes:
(a) receiving a connection request arising from the communication terminal of the calling user and indicating a social identifier of said called user, at least one social identifier of a user being associated with at least one private communication identifier of a communication terminal of the called user;
(b) identifying at least one private communication identifier on the basis of said social identifier of the called user indicated in said connection request as a function of at least one reachability rule, configured by the called user, associated with the private communication identifiers; and
(c) transmitting an appeal for setting UP a communication of the communication terminal of the calling user with a communication terminal on which the called user is reachable on the basis of the identified private communication identifier.

6. A connection device comprising
(a) means for receiving a connection request arising from the communication terminal of the calling user and indicating a social identifier of said called user, at least one social identifier of a user being associated with at least one private communication identifier of a communication terminal of the called user;
(b) means for identifying at least one private communication identifier on the basis of said social identifier of the called user indicated in said connection request as a function of at least one reachability rule, configured by the called user, associated with the private communication identifiers; and
(c) means for transmitting an appeal for setting up a communication of the communication terminal of the calling user with a communication terminal on which the called user is reachable on the basis of the identified private communication identifier.

7. A connection interface method on the basis of a social network of at least one communication terminal of a calling user with at least one communication terminal, associated with a private communication identifier, of a called user, said method comprising:
sending a connection request arising from the communication terminal of the calling user and indicating a social identifier of said called user in said social network, at least one social identifier of a user being associated with at least one private communication identifier of a communication terminal of the called user, said connection request making it possible to identify at least one private communication identifier on which said called user is reachable on the basis of said social identifier of the called user indicated in said connection request as a function of at least one reachability rule, configured by the called user, associated with the private communication identifiers.

8. The connection interface method as claimed in claim 7, wherein said method comprises a step of receiving a message of updating the connection request interface as a function of the reachability rules.

9. A non-transitory computer readable medium comprising a computer program product stored thereon and comprising instructions for implementation of a connection interface method on the basis of a social network of at least one communication terminal of a calling user with at least one communication terminal, associated with a private communication identifier, of a called user when the instructions are executed by a processor, wherein the method comprises:
sending a connection request arising from the communication terminal of the calling user and indicating a social identifier of said called user in said social network, at least one social identifier of a user being associated with at least one private communication identifier of a communication terminal of the called user, said connection request making it possible to identify at least one private communication identifier on which said called user is reachable on the basis of said social identifier of the called user indicated in said connection request as a function of at least one reachability rule, configured by the called user, associated with the private communication identifiers.

10. A method implemented by a communication terminal of a calling user consulting a social network, comprising:
sending a connection request and indicating a social identifier of said called user in the social network consulted by the calling user, at least one social identifier of a user being associated with at least one private communication identifier of a communication terminal of the called user, said connection request making it possible to identify at least one private communication identifier on which said called user is reachable on the basis of said social identifier of the called user indicated in said connection request as a function of at least one reachability rule, configured by the called user, associated with the private communication identifiers.

11. (canceled)

12. A method implemented by a communication terminal of a called user comprising:
receiving a communication setup appeal originating from a communication system having received, from a connection system, an appeal for setting up a communication of a communication terminal of a calling user with a communication terminal on which the called user is reachable on the basis of an identified private communication identifier, said private communication identifier having been identified on the basis of a social identifier of the called user indicated in a connection request as a function of at least one reachability rule, configured by the called user, associated with the private communication identifiers, said connection request arising from the communication terminal of the calling user, at least one social identifier of a user being associated with at least one private communication identifier of a communication terminal of the called user.

13. A communication terminal of a user comprising
a device configured to consult and interact with a social network allowing a sending of a connection request and indicating a social identifier of said called user in the social network consulted by the calling user, at least one social identifier of a user being associated with at least one private communication identifier of a communication terminal of the called user, said connection request making it possible to identify at least one private communication identifier on which said called user is reachable on the basis of said social identifier of the called user indicated in said connection request as a function of at least one reachability rule, configured by the called user, associated with the private communication identifiers.

14. A social directory system in which each user is identified by a social identifier, in which said social directory system comprises:
a device configured to enrich said social directory system and comprising a receiver of a connection interface, said connection interface allowing said social directory system to send a connection request arising from the communication terminal of the calling user and indicating a social identifier of said called user in said social network, at least one social identifier of a user being associated with at least one private communication identifier of a communication terminal of the called user, said connection request making it possible to identify at least one private communication identifier on which said called user is reachable on the basis of said social identifier of the called user indicated in said connection request as a function of at least one reachability rule, configured by the called user, associated with the private communication identifiers.

15. A system for providing a connection service, which comprises:
a management device configured for communication terminals of users comprising means for recording, in a set of private communication identifiers of a user, at least one private communication identifier declared by said user,
a device configured for anonymization of private communication identifier of communication terminals of users, comprising means for associating a social identifier of a user with each of the private communication identifiers recorded in a set of private communication identifiers of communication terminals declared by said user,
a connection device comprising
(a) means for receiving a connection request arising from the communication terminal of the calling user and indicating a social identifier of said called user, at least one social identifier of a user being associated with at least one private communication identifier of a communication terminal of the called user;
(b) means for identifying at least one private communication identifier on the basis of said social identifier of the called user indicated in said connection request as a function of at least one reachability rule, configured by the called user, associated with the private communication identifiers;
(c) means for transmitting an appeal for setting up a communication of the communication terminal of the calling user with a communication terminal on which the called user is reachable on the basis of the selected private communication identifier.
